(19) United States
(12) Patent Application Publication
(10) Pub. No.: US 2018/0060869 A1
(43) Pub. Date: Mar. 1, 2018

(54) METHOD AND SYSTEM FOR LOCATION SCORING BASED ON CARDHOLDER WALLET ITEM REDEMPTION

(71) Applicant: MasterCard International Incorporated, Purchase, NY (US)

(72) Inventor: Manoneet KOHLI, O'Fallon, MO (US)

(73) Assignee: MasterCard International Incorporated, Purchase, NY (US)

(21) Appl. No.: 15/254,334

(22) Filed: Sep. 1, 2016

(51) Int. Cl. G06Q 20/40; H04L 29/08; G06Q 20/32; G06Q 30/02; G06F 17/30

(52) U.S. Cl. CPC G06Q 20/4016; H04L 67/30; G06F 17/30312; G06Q 30/0224; G06F 17/30477; G06Q 20/3224

(57) ABSTRACT

A method for location scoring a transaction based on item redemption includes: receiving a redemption notification, the notification including an indication of redemption of an item; receiving a transaction message related to a payment transaction, the transaction message being formatted based standards and including a plurality of data elements including a first data element configured to store a geographic location, a second data element configured to store a transaction time, and one or more additional data elements configured to store additional transaction data; determining a location score for the payment transaction based on a correspondence between the geographic location and a location of the redeemed item and a correspondence between the transaction time and a time of the redeemed item; executing a query on the transaction message to insert the determined location score into a data element of the plurality of data elements; and electronically transmitting the transaction message.

### FIELD

The present disclosure relates to the location scoring of a payment transaction based on item redemption, specifically the use of the redemption of an item that is associated with a geographic location for the scoring of payment transactions based on a correspondence between the redeemed item's geographic location and the location of the payment transaction.

### BACKGROUND

Billions of dollars are exchanged every day in commerce via the millions upon millions of payment transactions that are processed every day via payment networks. Due to the vast amounts of money at stake, many financial institutions are highly interested in detecting the likelihood of fraud of a payment transaction. While fraud is a business concern, it requires sophisticated technology to detect in a payment network as the number of transactions can be in the millions and it is not possible to have human review of each one for fraud. One aspect of a transaction that is often considered in fraud determinations is geographic location. Specifically, payment networks and financial institutions may use the transaction's geographic location to determine a likelihood of fraud.

In some instances, the geographic location may indicate a likelihood of fraud by virtue of the location itself, which may be in a city, country, or other geographic area where fraud is more prevalent. In other instances, the geographic location of the payment transaction may be compared to a location associated with the consumer involved in the transaction. In such instances, methods have been developed to identify a geographic area associated with the consumer, based on past transaction history to determine where the consumer lives and works, or to identify the geographic location of the consumer at the time of the transaction based on a mobile computing device associated with the consumer.

However, such a method is only suitable if the consumer has a mobile computing device, allows for the geographic location of their mobile computing device to be captured, and if the consumer has their mobile computing device with them at the time of the transaction. As a result, the use of only the consumer's mobile computing device may be inconsistent as a method in the determination of a likelihood of fraud for a payment transaction. Thus, there is a need for a technological solution to location score a payment transaction based on a known geographic location of a consumer at the time of the payment transaction that may have higher consistent and accuracy than existing methods.

### SUMMARY

The present disclosure provides a description of systems and methods for location scoring a transaction based on item redemption. The systems and methods discussed herein utilize the redemption of an item by a consumer, such as a concert ticket or other voucher for event attendance, that is associated with a known geographic location for consideration in identifying a location score for the payment transaction. The redemption of the item by the consumer implies attendance of the consumer at a related event or is otherwise at the geographic location of the redemption, thus providing an accurate geographic location of the consumer for consideration in fraud determinations without requiring use and reporting of a mobile computing device location.

A method for location scoring a transaction based on item redemption includes: receiving, by a receiving device of a processing server, a redemption notification, wherein the redemption notification includes an indication of redemption of an item; receiving, by the receiving device of the processing server, a transaction message related to a payment transaction, wherein the transaction message is formatted based on one or more standards and includes at least a plurality of data elements including at least a first data element configured to store a geographic location, a second data element configured to store a transaction time, and one or more additional data elements configured to store additional transaction data; determining, by a determination module of the processing server, a location score for the payment transaction based on a correspondence between the geographic location and a location of the redeemed item and a correspondence between the transaction time and a time of the redeemed item; executing, by a querying module of the processing server, a query on the transaction message to insert the determined location score into a data element of the plurality of data elements; and electronically transmitting, by a transmitting device of the processing server, the transaction message including the determined location score.

A system for location scoring a transaction based on item redemption includes: a receiving device of a processing server configured to receive a redemption notification, wherein the redemption notification includes an indication of redemption of an item, and a transaction message related to a payment transaction, wherein the transaction message is formatted based on one or more standards and includes at least a plurality of data elements including at least a first data element configured to store a geographic location, a second data element configured to store a transaction time, and one or more additional data elements configured to store additional transaction data; a determination module of the processing server configured to determine a location score for the payment transaction based on a correspondence between the geographic location and a location of the redeemed item and a correspondence between the transaction time and a time of the redeemed item; a querying module of the processing server configured to execute a query on the transaction message to insert the determined location score into a data element of the plurality of data elements; and a transmitting device of the processing server configured to electronically transmit the transaction message including the determined location score.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the location scoring of payment transactions based on item redemption in accordance with exemplary embodiments.

FIG. 2 is a block diagram illustrating a processing server for identifying location scores of payment transactions based on item redemption use in the system of FIG. 1 in accordance with exemplary embodiments.

FIG. 3 is a flow diagram illustrating a process for the identification of a location score based on item redemption data using the system of FIG. 1 in accordance with exemplary embodiments.

FIG. 4 is a flow diagram illustrating a process for identification and usage of location scores based on item redemption data using the processing server of FIG. 2 in accordance with exemplary embodiments.

FIG. 5 is a flow chart illustrating an exemplary method for location scoring a transaction based on item redemption in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

### System for Location Scoring Based on Item Redemption

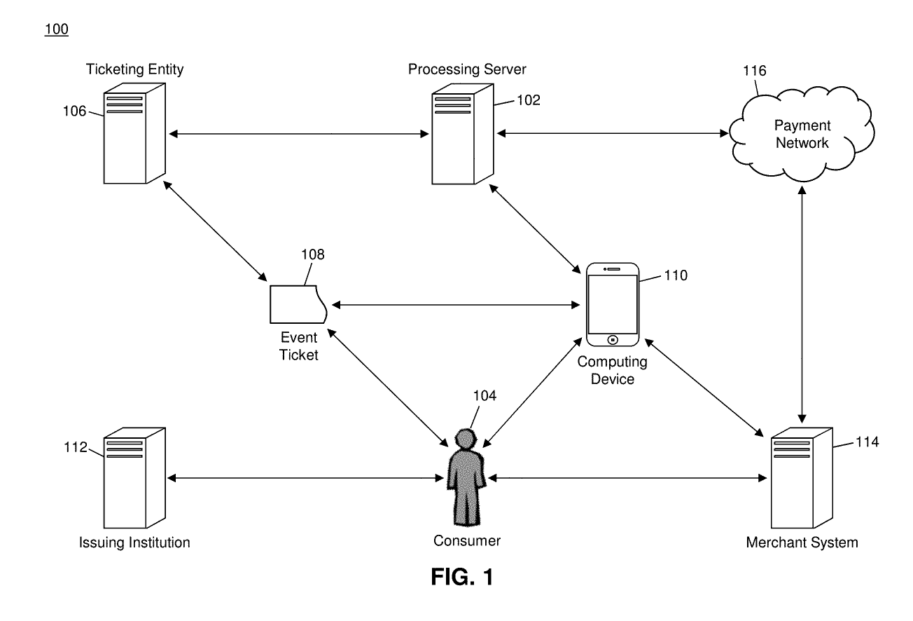

FIG. 1 illustrates a system 100 for the location scoring of payment transactions based on geographic location as corresponding to the geographic location of a redeemed item.

The system 100 may include a processing server 102. The processing server 102, discussed in more detail below, may be configured to identify location scores for payment transactions based on a geographic location of the payment transaction as compared to a geographic location associated with an item redeemed by a consumer 104. In the system 100, the consumer 104 may purchase an item to be redeemed from a ticketing entity 106. The ticketing entity 106 may provide the consumer 104 with an event ticket 108 for an event at a set event location and time. It will be apparent to persons having skill in the relevant art that, in other embodiments, any item that is associated with a specific geographic location that may be redeemed may be used in place of the event ticket 108, such as a coupon that must be redeemed at a specific merchant location, a gift voucher that must be turned in at a specific location, an airline ticket, etc. In such instances, the ticketing entity 106 may be any entity configured to issue such an item and manage redemption and tracking thereof of the item.

In some embodiments, the consumer 104 may possess a computing device 110. In such embodiments, the computing device 110 may be configured to store the event ticket 108 as an electronic ticket therein using an application program configured therefor. For instance, the computing device 110 may have an electronic wallet application program installed therein, which may be configured to store electronic tickets, including the event ticket 108, for redemption. The computing device 110 may thus be configured to display, transmit, or otherwise output the event ticket 108 and/or details associated therewith for redemption of the event ticket 108. The computing device 110 may be any type of device suitable for use in performing the functions discussed herein, such as a desktop computer, laptop computer, notebook computer, tablet computer, cellular phone, smart phone, smart watch, smart television, wearable computing device, implantable computing device, etc.

At the appropriate time, if applicable, the consumer 104 may redeem the event ticket 108 with the ticketing entity 106. Redemption of the event ticket 108 may be performed by presenting the event ticket 108 at the associated geographic location, and at the appropriate event time, if applicable. The ticketing entity 106 may be configured to register the redemption of the event ticket 108, such as by using a computing system configured therefore. For example, the event ticket 108 may include a barcode that may be scanned to read an item identifier encoded therein, which may be updated in the systems of the ticketing entity 106 to indicate redemption thereof. In embodiments where a computing device 110 may be used, a barcode may be read that is displayed by the computing device 110 or the computing device 110 may electronically transmit the item identifier or other data indicative of the event ticket 108 to the ticketing entity 106 to indicate the redemption.

After redemption of the event ticket 108, the processing server 102 may receive a notification of the redemption of the event ticket 108. In some embodiments, the ticketing entity 106 may electronically transmit a data signal to the processing server 102 that is superimposed or otherwise encoded with a redemption notification. In other embodiments, the computing device 110 may electronically transmit a data signal to the processing server 102 that is superimposed or otherwise encoded with the redemption notification. Communications to the processing server 102 may be made using any suitable communication network and method, such as the Internet, cellular communication networks, local area networks, etc.

The redemption notification may include any data associated with the event ticket 108 being redeemed that may be used in performing the functions discussed herein. Such data may include, for example, an item identifier, a primary account number, an event time, an event location, etc. The item identifier may be a unique value that may be suitable for use in identification of the related event ticket 108 and/or redeemed consumer 104, such as an identification number. The primary account number may be an account number for a transaction account used for the purchase of or that is otherwise associated with the event ticket 108. The event time and event location may be a time, if applicable, and a geographic location of the related event.

The processing server 102 may receive the redemption notification and may use the information in determining a location score for a payment transaction that is conducted by the consumer 104 subsequent to redemption of the event ticket 108. In the system 100, an issuing institution 112 may issue a transaction account to the consumer 104. The issuing institution 112 may be any financial institution, such as an issuing bank, or other entity configured to issue transaction accounts to consumers 104 for use in funding payment transactions. The issuing institution 112 may provide the consumer 104 with payment credentials associated with the issued transaction account, which the consumer 104 may present to a merchant system 114 for a payment transaction. The payment credentials may be issued to the consumer 104 using any suitable method, such as via a payment card or provisioning to the computing device 110, such as in the electronic wallet application program used to store and redeem the event ticket 108. The consumer 104 may present the payment credentials to the merchant system 114, which may receive the credentials via suitable methods associated therewith, such as the reading of the payment card or receipt of payment credentials from the computing device 110 using near field communication.

The merchant system 114 may receive the payment credentials and other transaction data for the payment transaction, which may then be electronically transmitted to a payment network 116 for processing. The other transaction data may include at least a geographic location for the payment transaction, as well as a transaction amount, transaction time, transaction date, merchant identifier, merchant category code, merchant name, currency type, merchant data, product data, issuer data, acquirer data, offer data, reward data, loyalty data, etc. The transaction data may be electronically transmitted to the payment network 116 directly by the merchant system 114, or via one or more intermediate entities, such as an acquiring institution or gateway processor.

In some instances, the transaction data may be included in a transaction message, which may be formatted by the merchant system 114 or one of the intermediate entities. A transaction message may be a specially formatted data message that is formatted pursuant to one or more standards governing the exchange of financial transaction messages, such as the International Organization of Standardization's ISO 8583 or ISO 20022 standards. The transaction message may include a message type indicator, which may be indicative of a type of the transaction message, such as an authorization request or authorization response. The transaction message may also include a plurality of data elements, where each data element is configured to store transaction data for the related payment transaction, such as a data element configured to store a primary account number, a data element configured to store a geographic location, etc. In some embodiments, a transaction message may also include one or more bitmaps, which may be configured to indicate the data elements included in the transaction message and data stored therein.

The payment network 116 may receive the transaction message for the payment transaction involving the consumer 104 and the merchant system 114, and may forward the transaction message to the processing server 102 for identification of a location score. In some embodiments, the processing server 102 may be part of the payment network 116 and may receive the transaction message via internal communication methods. In other embodiments, the processing server 102 may be external to the payment network 116 and may receive the transaction message using the payment rails associated with the payment network 116 or other specially configured communication network suitable for communication of transaction messages.

The processing server 102 may then identify a location score for the payment transaction. The location score may be based on at least a correspondence between the geographic location of the payment transaction, as indicated in the corresponding data element, and the geographic location of the consumer 104 based on the item redemption. In some instances, the redemption notification may be stored in one or more data elements in the transaction message, such as may be provided to the merchant system 114 for inclusion therein by the computing device 110 or the consumer 104. In other instances, the redemption notification may be identified based on data stored in the transaction message, such as the item identifier or primary account number. For example, the consumer 104 may use the same transaction account to purchase the event ticket 108 and fund the payment transaction with the merchant system 114. The processing server 102 may thus identify the consumer's redemption of the event ticket 108 based on usage of the same primary account number in the transaction message.

The correspondence between the transaction's geographic location and the geographic location associated with the item redemption may be used to identify the location score, where a high correspondence between the geographic locations may indicate a low likelihood of fraud. For instance, if the merchant is located at or near the venue for the event, the likelihood of fraud, based on the location, may be low. In some instances, the location score may also be based on a correspondence of times, such as the transaction time stored in a corresponding data element included in the transaction message and a time associated with the event, such as may be received in the redemption notification. For example, a transaction occurring at the venue right after the event started may indicate a low likelihood of fraud, while a transaction occurring the next morning may indicate a high likelihood that the payment card was stolen.

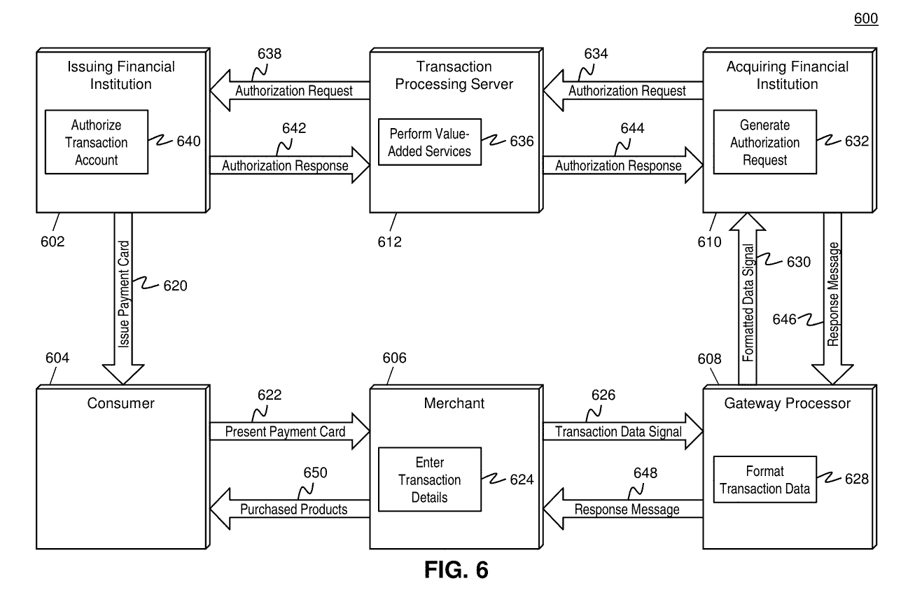

The processing server 102 may identify a location score that indicates the likelihood of fraud based on the correspondence(s). In some instances, the score may be a numeric value, such as a value between 1-100, where a higher number indicates a higher likelihood of fraud. The processing server 102 may store the location score in a data element included in the transaction message, which may then be forwarded to the issuing institution 112, either directly by the processing server 102 or via the payment network 116 for further processing using traditional methods and systems. Additional information regarding the traditional processing of payment transactions is discussed in more detail below with respect to the process 600 illustrated in FIG. 6. The issuing institution 112 may approve or deny the payment transaction based on, at least in part, the location score identified by the processing server 102.

In some embodiments, the processing server 102 may be configured to pre-approve or deny payment transactions on behalf of the issuing institution based on the location score. For instance, the issuing institution 112 may provide the processing server 102 with a threshold score for pre-approval and/or a threshold score for denial of a payment transaction. If the location score identified by the processing server 102 is below the threshold score for pre-approval, the processing server 102 may generate a transaction message indicated as an authorization response that indicates approval of the payment transaction and may return the authorization response to the payment network 112 as pre-approval. In some such cases, the issuing institution 112 may provide a maximum transaction amount, which may be a limit for pre-approving transactions. If the location score identified by the processing server 102 is above the threshold score for denial, the processing server 102 may generate an authorization response indicating denial of the payment transaction, which may be returned to the payment network 116 to deny the transaction. In such embodiments, the processing of the payment transaction may be accelerated as the processing server 102 may approve or deny some payment transactions on behalf of the issuing institution 112, requiring less communications and processing.

The methods and system discussed herein may enable the location scoring of payment transactions based on a geographic location of a consumer 104 that is identified based on the redemption of an item having a known geographic location. By using item redemption, the location of a consumer 104 may be inferred without requiring the use of a consumer computing device 110 and, even if the computing device 110 is used for redemption of the item, may still be inferred without requiring the computing device 110 to report its geographic location. As a result, the processing server 102 may identify an accurate location score based on item redemption that may be suitable for use by issuing institutions 112 in determining approval or denial of payment transactions.

### Processing Server

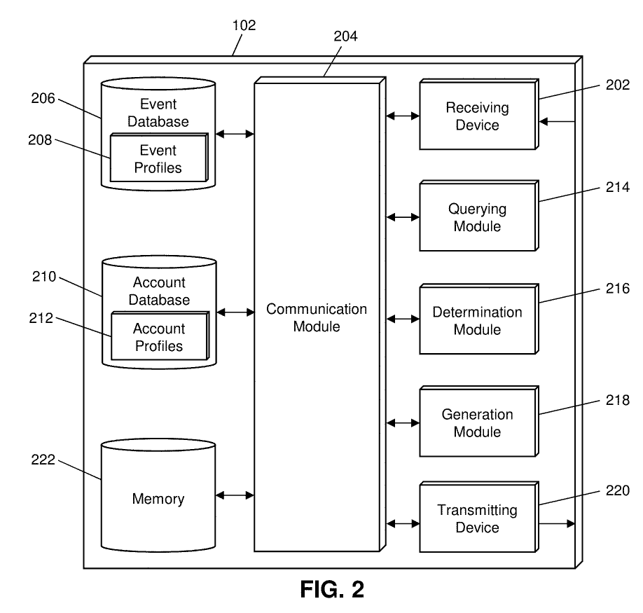

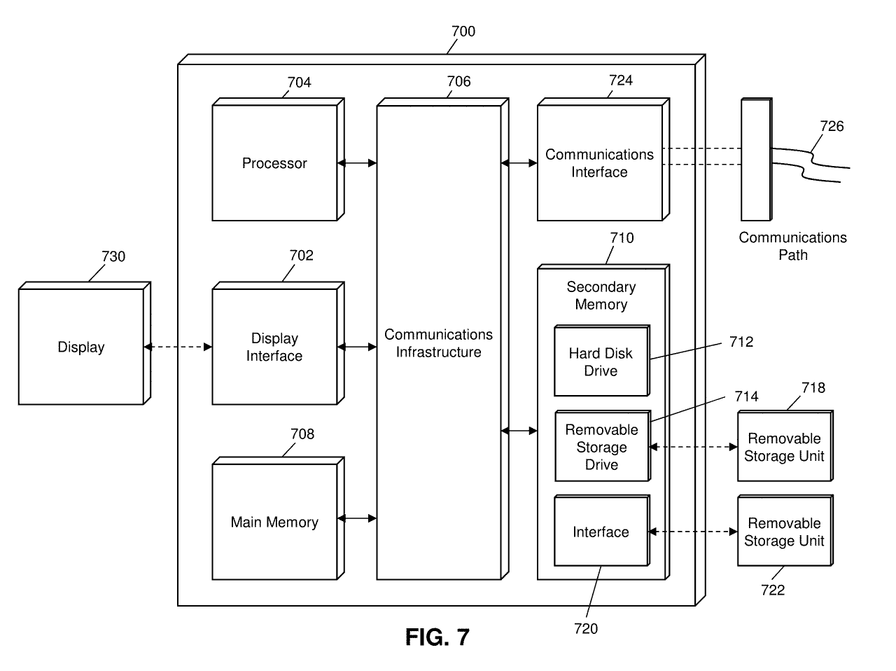

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 116 for the transmission of transaction messages that include sensitive financial data and information. In some instances, the receiving device 202 may also be configured to receive data from ticketing entities 106, computing devices 110, payment networks 116, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by ticketing entities 106 and computing devices 110, which may be superimposed or otherwise encoded with redemption notifications. Redemption notifications may include data indicating redemption of an event ticket 108, such as an item identifier, event identifier, primary account number, event time, event location, etc. The receiving device 202 may also be configured to receive data signals electronically transmitted by payment networks 116, which may be superimposed or otherwise encoded with transaction messages for payment transactions. In some embodiments, the receiving device 202 may be further configured to receive data for storage in the processing server 102, as discussed in more detail below, such as event data received from the ticketing entity 106.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, determination module 216, generation module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may also include an event database 206. The event database 206 may be configured to store a plurality of event profiles 208 using a suitable data storage format and schema. The event database 206 may be a relational database that utilizes structured query language for the storage, identification, modifying, updating, accessing, etc. of structured data sets stored therein. Each event profile 208 may be a structured data set configured to store data related to an event. Each event profile 208 may include at least an event identifier, event time, and event location. The event identifier may be a unique value associated with the related event used for identification thereof. The event time and event location may be a time and/or date and a geographic location where the related event takes place.

The processing server 102 may also include an account database 210. The account database 210 may be configured to store a plurality of account profiles 212 using a suitable data storage format and schema. The account database 210 may be a relational database that utilizes structured query language for the storage, identification, modifying, updating, accessing, etc. of structured data sets stored therein. Each account profile 212 may be a structured data set configured to store data related to a transaction account. Each account profile 212 may include at least a primary account number and one or more item identifiers. The primary account number may be the account number for the related transaction account. The one or more item identifiers may be item identifiers for events for which event tickets 108 were purchased and/or redeemed for the related transaction account.

The processing server 102 may include a querying module 214. The querying module 214 may be configured to execute queries on databases to identify information. The querying module 214 may receive one or more data values or query strings, and may execute a query string based thereon on an indicated database, such as the event database 206, to identify information stored therein. The querying module 214 may then output the identified information to an appropriate engine or module of the processing server 102 as necessary. The querying module 214 may, for example, execute a query on the event database 206 to identify an event profile 208 related to an event that corresponds to a redemption notification, such as based on an item identifier or event identifier included therein. The querying module 214 may also execute queries on the account database 210, such as to identify an account profile 212 related to a received transaction message based on the primary account number stored therein. The querying module 214 may also be configured to execute queries on transaction messages, such as for the insertion of data into data elements included in the transaction message.

The processing server 102 may also include a determination module 216. The determination module 216 may be configured to perform determinations for the processing server 102 for performing the functions discussed herein. The determination module 216 may receive instructions as input, may perform determinations based on the instructions, and output a result of the determinations to another module or engine of the processing server 102. In some instances, the determination module 216 may receive data for use in the determinations as input. In other instances, the determination module 216 may be configured to obtain data for use in determinations, such as by instructing the querying module 214 to perform corresponding queries. The determination module 216 may be configured to determine a location score for a payment transaction, where the location score is based on a correspondence between the geographic location of a redeemed item and the geographic location of a payment transaction, and, if applicable, a correspondence between a time for the redeemed item and the transaction time of the payment transaction. The determination module 216 may also be configured to determine pre-approval or denial of payment transactions based on location scores and predetermined thresholds.

The processing server 102 may also include a generation module 218. The generation module 218 may be configured to generate data signals and other data for use in performing the functions of the processing server 102 as discussed herein. The generation module 218 may receive an instruction, may generate data or a data signal based thereon, and may provide the generated data or data signal to another module or engine of the processing server 102. In some instances, the generation module 218 may receive data for inclusion in the data signals or used in the generation thereof as input. In other in instances, the generation module 218 may be configured to identify (e.g., via instruction to the querying module 214) data for usage. The generation module 218 may be configured to generate data signals for electronic transmission to the ticketing entity 106, computing device 110, or payment network 116. In some embodiments, the generation module 218 may be configured to generate or to modify existing transaction messages, such as based on pre-approval or denial determinations.

The processing server 102 may also include a transmitting device 220. The transmitting device 220 may be configured to transmit data over one or more networks via one or more network protocols. In some embodiments, the transmitting device 220 may be configured to transmit data over the payment rails, such as using specially configured infrastructure associated with payment networks 116 for the transmission of transaction messages that include sensitive financial data and information, such as identified payment credentials. In some instances, the transmitting device 220 may be configured to transmit data to ticketing entities 106, computing devices 110, payment networks 116, and other entities via alternative networks, such as the Internet. In some embodiments, the transmitting device 220 may be comprised of multiple devices, such as different transmitting devices for transmitting data over different networks, such as a first transmitting device for transmitting data over the payment rails and a second transmitting device for transmitting data over the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to ticketing entities 106 and computing devices 110, which may be superimposed or otherwise encoded with data requests, such as requesting event data, account data, or item redemption data for use in performing the functions of the processing server 102 discussed herein. The transmitting device 220 may be configured to electronically transmit data signals to payment networks 116 and/or issuing institutions 112, which may be electronically transmitted using the payment rails or another suitable communication network, and may be superimposed or otherwise encoded with transaction messages, including authorization requests and authorization responses.

The processing server 102 may also include a memory 222. The memory 222 may be configured to store data for use by the processing server 102 in performing the functions discussed herein. The memory 222 may be configured to store data using suitable data formatting methods and schema and may be any suitable type of memory, such as read-only memory, random access memory, etc. The memory 222 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 222 may be comprised of or may otherwise include a relational database that utilizes structured query language for the storage, identification, modifying, updating, accessing, etc. of structured data sets stored therein.

### Process for Location Scoring Based on Item Redemption

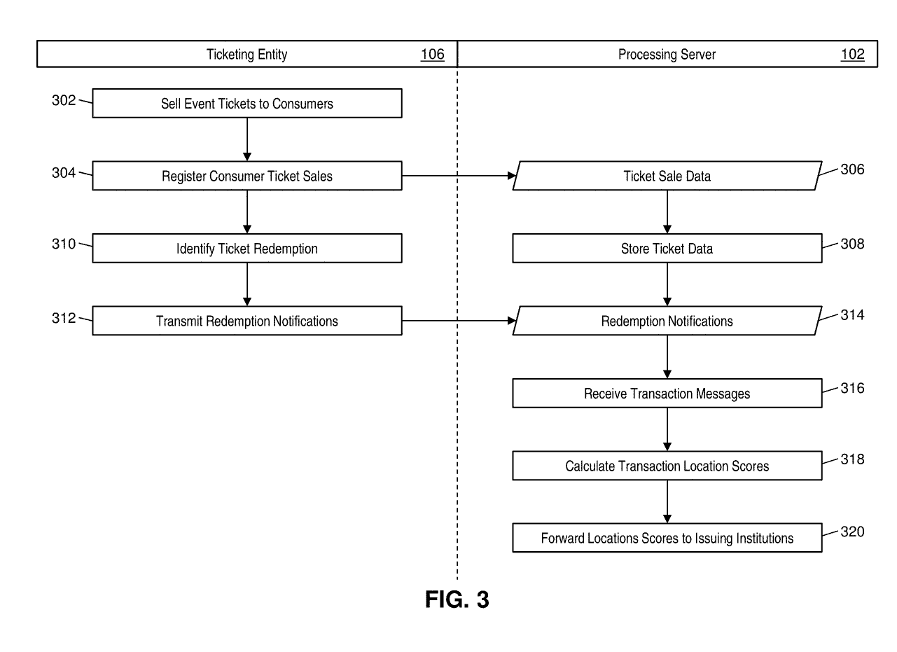

FIG. 3 illustrates a process for the location scoring of a payment transaction based on redemption of an item associated with a geographic location, such as being associated with an event having a known geographic location.

In step 302, the ticketing entity 106 may sell event tickets 108 to consumers 104 for an event having a known event time and location. As part of the selling of event tickets 108, the ticketing entity 106 may issue physical event tickets 108 to the consumers 104 or issue electronic event tickets to consumers 104 via associated computing devices 110. In step 304, the ticketing entity 106 may register the event and consumer ticket sales with the processing server 102. As part of the registration, the ticketing entity 106 may electronically transmit a data signal to the processing server 102 that is superimposed or otherwise encoded with ticket sales and event data.

In step 306, the receiving device 202 of the processing server 102 may receive the event and ticket sales data. The event data may include the time and location of the event as well as an associated event identifier. The ticket sales data may include an item identifier associated with each of the consumers 104 that purchased an event ticket 108, which may be a primary account number for the transaction account used to fund the purchase or other identification value. In step 308, the ticket and event data may be stored in the processing server 102. The querying module 214 of the processing server 102 may execute queries on the event database 206 and account database 210 of the processing server 102 to store an event profile 208 and account profiles 212 therein, respectively.

In step 310, the ticketing entity 106 may identify redemption of event tickets 108 at the time of the associated event. In step 312, the ticketing entity 106 may electronically transmit data signals superimposed or otherwise encoded with redemption notifications for each of the ticket redemptions to the processing server 102. In step 314, the receiving device 202 of the processing server 102 may receive the redemption notifications. Each of the redemption notifications may include at least the event identifier and the item identifier corresponding to the respective event ticket 108. In step 316, the receiving device 202 may receive transaction messages for payment transactions from the payment network 116 via payment rails associated therewith. Each transaction message may include a message type indicator indicative of an authorization request and include a plurality of data elements including at least a first data element configured to store a geographic location, a second data element configured to store a transaction time, a third data element configured to store an item identifier, and one or more additional data elements configured to store additional transaction data.

In step 318, the determination module 216 of the processing server 102 may determine location scores for each of the received transaction messages. The location score for each transaction message may be based on correspondences between the event location and the geographic location stored in the corresponding data element included in the transaction message and the event time and the transaction time stored in the corresponding data element. As part of the determination, the querying module 214 of the processing server 102 may execute a query on each transaction message to insert the respective location score into a corresponding data element included therein. In step 320, the transmitting device 220 of the processing server 102 may electronically transmit the updated transaction messages to the issuing institutions 112 associated with the transaction accounts used in each, or to the payment network 116 for forwarding thereto, for processing based on the determined location scores.

### Process for Transaction Pre-Approval Based on Location Scoring

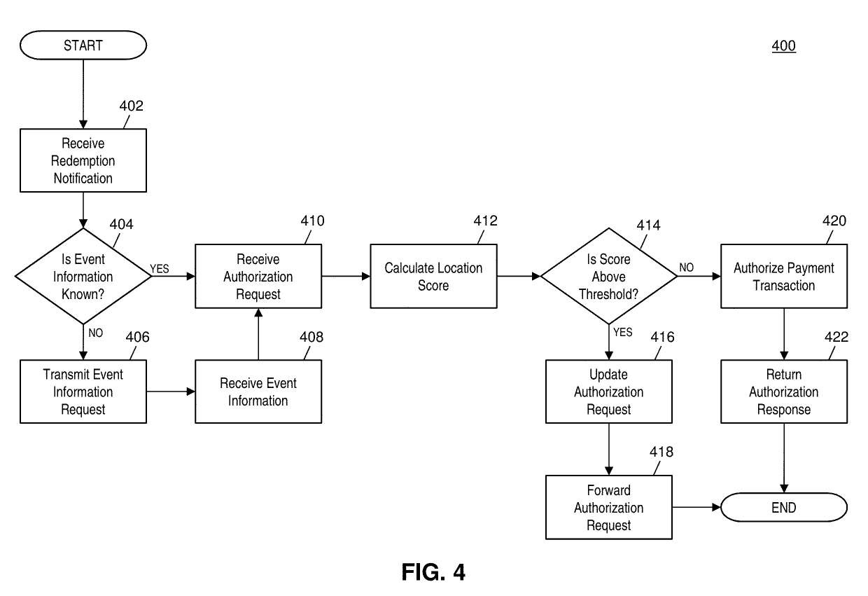

FIG. 4 illustrates a process 400 executed by the processing server 102 for the processing of a payment transaction based on a location score identified based on item redemption, which may include pre-approval of the payment transaction based on the identified location score.

In step 402, the receiving device 202 of the processing server 102 may receive a redemption notification. The redemption notification may include at least an indication of item redemption, such as the redemption of an event ticket 108 for an event. In step 404, the processing server 102 may determine if event information is known for the event associated with the received redemption notification. The determination may be based on the execution of a query on the event database 206 by the querying module 214 of the processing server 102 to identify if an event profile 208 exists that corresponds to the redemption notification, such as by including an event identifier included in the redemption notification.

If no event profile 208 is identified, then, in step 406, the transmitting device 220 of the processing server 102 may electronically transmit a data request to the ticketing entity 106 to request the event time and location for the event. In step 408, the receiving device 202 of the processing server 102 may receive the event time and location back from the ticketing entity 106. Once the event information has been received, or if, in step 404, the processing server 102 determines that the event information is already known, then, in step 410, the receiving device 202 may receive an authorization request for a payment transaction. The authorization request may be a transaction message received from the payment network 116 via payment rails associated therewith, which may include a message type indicator indicative of an authorization request and a plurality of data elements configured to store transaction data including an item identifier or primary account number, a transaction location, and a transaction time.

In step 412, the determination module 216 of the processing server 102 may calculate a location score for the payment transaction. The location score may be based on a correspondence between the event location and the transaction location, as well as the event time and the transaction time. The location score may indicate a likelihood of fraud, such as where a higher correspondence between the event location and transaction location and/or the event time and transaction time may indicate a lower likelihood of fraud. In step 414, the determination module 216 may determine if the location score for the payment transaction is above a predetermined threshold. In some instances, the threshold may be provided by an issuing institution 112 associated with the transaction account used to fund the payment transaction, such as may be identified based on data stored in the data elements included in the authorization request, such as the primary account number or an issuer identifier.

If the location score is above the predetermined threshold, then, in step 416, the querying module 214 of the processing server 102 may execute a query on the authorization request to update the authorization request by inserting the calculated location score into a corresponding data element in the authorization request. In step 418, the transmitting device 220 of the processing server 102 may electronically transmit the updated authorization request to the issuing institution 112 associated therewith for processing using traditional methods or systems.

If, in step 414, the determination module 216 determines that the location score is not above the predetermined threshold, which may indicate a very low likelihood of fraud, then, in step 416, the processing server 102 may authorize the payment transaction. Authorization of the payment transaction may include the generation of an authorization response, or modification of the authorization request to be an authorization response, which may be a transaction message that includes a message type indicator indicative of an authorization response and a plurality of data elements, which may include the data elements included in the authorization request, as well as a data element that is configured to store a response code, where the response code indicates approval of the payment transaction. In step 422, the transmitting device 220 of the processing server 102 may electronically transmit the authorization response to the payment network 116 via the payment rails associated therewith for forwarding to the merchant system 114 for finalization of the payment transaction.

### Exemplary Method for Location Scoring a Transaction Based on Item Redemption

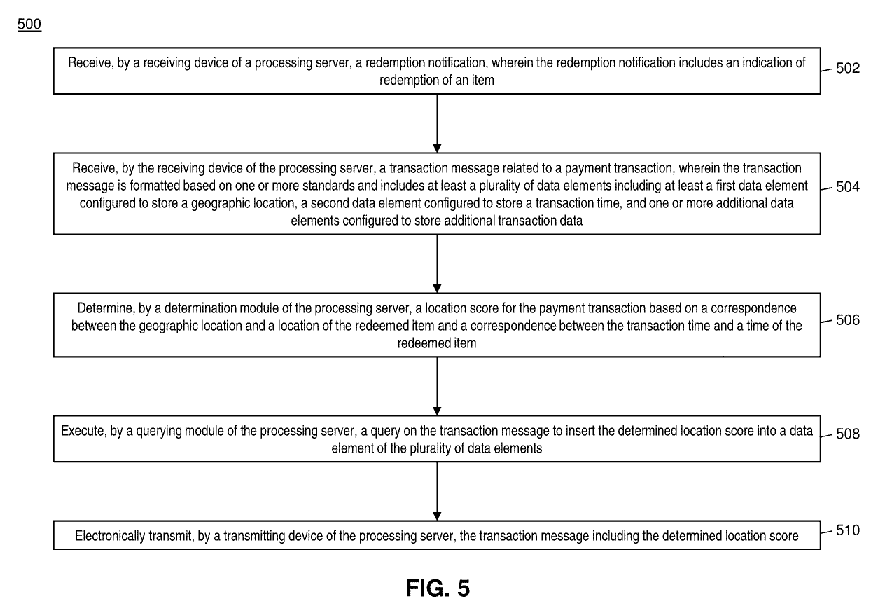

FIG. 5 illustrates a method 500 for the identification of a location score for a payment transaction based on a location and time associated with a redeemed item.

In step 502, a redemption notification may be received by a receiving device (e.g., the receiving device 202) of a processing server (e.g., the processing server 102), wherein the redemption notification includes an indication of redemption of an item. In step 504, a transaction message related to a payment transaction may be received by the receiving device of the processing server, wherein the transaction message is formatted based on one or more standards and includes at least a plurality of data elements including at least a first data element configured to store a geographic location, a second data element configured to store a transaction time, and one or more additional data elements configured to store additional transaction data.

In step 506, a location score for the payment transaction may be determined by a determination module (e.g., the determination module 216) of the processing server based on a correspondence between the geographic location and a location of the redeemed item and a correspondence between the transaction time and a time of the redeemed item. In step 508, a query may be executed by a querying module (e.g., the querying module 214) of the processing server on the transaction message to insert the determined location score into a data element of the plurality of data elements. In step 510, the transaction message including the determined location score may be electronically transmitted by a transmitting device (e.g., the transmitting device 220) of the processing server.

In one embodiment, the transaction message may be electronically transmitted to a financial institution associated with a transaction account involved in the related payment transaction. In a further embodiment, the transaction account may be associated with a primary account number stored in a corresponding data element included in the transaction message. In some embodiments, the redemption notification may be included in an additional data element included in the transaction message.

In one embodiment, the method 500 may further include: storing, in an event database (e.g., the event database 206) of the processing server, a plurality of event profiles (e.g., event profiles 208), wherein each event profile includes data related to an event including at least an event identifier, an event time, and an event location; and executing, by the querying module of the processing server, a query on the event database to identify a specific event profile associated with the redeemed item, wherein the redemption notification further includes the event identifier included in the specific event profile, the location of the redeemed item is the event location included in the specific event profile, and the time of the redeemed item is the event time included in the specific event profile. In some embodiments, the location of the redeemed item and the time of the redeemed item may be included in the redemption notification.

In one embodiment, the method 500 may also include: electronically transmitting, by the transmitting device of the processing server, a data request to a third party (e.g., the ticketing entity 106), wherein the data request includes at least an item identifier further included in the redemption notification; and receiving, by the receiving device of the processing server, redemption data from the third party, wherein the redemption data includes at least the location of the redeemed item and the time of the redeemed item. In some embodiments, the redemption notification may further include a primary account number, and the transaction message may include an additional data element configured to store the primary account number.

In one embodiment, the method 500 may further include storing, in an account database (e.g., the account database 210) of the processing server, an account profile (e.g., account profile 212) related to a transaction account, wherein the account profile includes at least a primary account number and one or more item identifiers, wherein the redemption notification further includes an item identifier included in the one or more item identifiers, and the transaction message includes an additional data element configured to store the primary account number. In some embodiments, the redemption notification may originate from an electronic wallet configured to convey payment credentials stored in the one or more additional data elements included in the received transaction message.

### Payment Transaction Processing System and Process

FIG. 6 illustrates a transaction processing system and a process 600 for the processing of payment transactions in the system, which may include the processing of thousands, millions, or even billions of transactions during a given period (e.g., hourly, daily, weekly, etc.). The process 600 and steps included therein may be performed by one or more components of the system 100 discussed above, such as the processing server 102, consumer 104, computing device 110, merchant system 114, payment network 106, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3-5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8683 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 8683 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 660, assuming the transaction was approved, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 612. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the processing server of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for location scoring in a transaction based on item redemption. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for location scoring a transaction based on item redemption, comprising:
receiving, by a receiving device of a processing server, a redemption notification, wherein the redemption notification includes an indication of redemption of an item;
receiving, by the receiving device of the processing server, a transaction message related to a payment transaction, wherein the transaction message is formatted based on one or more standards and includes at least a plurality of data elements including at least a first data element configured to store a geographic location, a second data element configured to store a transaction time, and one or more additional data elements configured to store additional transaction data;
determining, by a determination module of the processing server, a location score for the payment transaction based on a correspondence between the geographic location and a location of the redeemed item and a correspondence between the transaction time and a time of the redeemed item;
executing, by a querying module of the processing server, a query on the transaction message to insert the determined location score into a data element of the plurality of data elements; and
electronically transmitting, by a transmitting device of the processing server, the transaction message including the determined location score.

2. The method of claim 1, wherein the transaction message is electronically transmitted to a financial institution associated with a transaction account involved in the related payment transaction.

3. The method of claim 2, wherein the transaction account is associated with a primary account number stored in a corresponding data element included in the transaction message.

4. The method of claim 1, wherein the redemption notification is included in an additional data element included in the transaction message.

5. The method of claim 1, further comprising:
storing, in an event database of the processing server, a plurality of event profiles, wherein each event profile includes data related to an event including at least an event identifier, an event time, and an event location; and
executing, by the querying module of the processing server, a query on the event database to identify a specific event profile associated with the redeemed item, wherein
the redemption notification further includes the event identifier included in the specific event profile,
the location of the redeemed item is the event location included in the specific event profile, and
the time of the redeemed item is the event time included in the specific event profile.

6. The method of claim 1, wherein the location of the redeemed item and the time of the redeemed item are included in the redemption notification.

7. The method of claim 1, further comprising:
electronically transmitting, by the transmitting device of the processing server, a data request to a third party, wherein the data request includes at least an item identifier further included in the redemption notification; and
receiving, by the receiving device of the processing server, redemption data from the third party, wherein the redemption data includes at least the location of the redeemed item and the time of the redeemed item.

8. The method of claim 1, wherein
the redemption notification further includes a primary account number, and
the transaction message includes an additional data element configured to store the primary account number.

9. The method of claim 1, further comprising:
storing, in an account database of the processing server, an account profile related to a transaction account, wherein the account profile includes at least a primary account number and one or more item identifiers, wherein
the redemption notification further includes an item identifier included in the one or more item identifiers, and
the transaction message includes an additional data element configured to store the primary account number.

10. The method of claim 1, wherein the redemption notification originates from an electronic wallet configured to convey payment credentials stored in the one or more additional data elements included in the received transaction message.

11. A system for location scoring a transaction based on item redemption, comprising:
a receiving device of a processing server configured to receive
a redemption notification, wherein the redemption notification includes an indication of redemption of an item, and
a transaction message related to a payment transaction, wherein the transaction message is formatted based on one or more standards and includes at least a plurality of data elements including at least a first data element configured to store a geographic location, a second data element configured to store a transaction time, and one or more additional data elements configured to store additional transaction data;
a determination module of the processing server configured to determine a location score for the payment transaction based on a correspondence between the geographic location and a location of the redeemed item and a correspondence between the transaction time and a time of the redeemed item;
a querying module of the processing server configured to execute a query on the transaction message to insert the determined location score into a data element of the plurality of data elements; and
a transmitting device of the processing server configured to electronically transmit the transaction message including the determined location score.

12. The system of claim 11, wherein the transaction message is electronically transmitted to a financial institution associated with a transaction account involved in the related payment transaction.

13. The system of claim 12, wherein the transaction account is associated with a primary account number stored in a corresponding data element included in the transaction message.

14. The system of claim 11, wherein the redemption notification is included in an additional data element included in the transaction message.

15. The system of claim 11, further comprising:
an event database of the processing server configured to store a plurality of event profiles, wherein each event profile includes data related to an event including at least an event identifier, an event time, and an event location, wherein
the querying module of the processing server is further configured to execute a query on the event database to identify a specific event profile associated with the redeemed item,
the redemption notification further includes the event identifier included in the specific event profile,
the location of the redeemed item is the event location included in the specific event profile, and
the time of the redeemed item is the event time included in the specific event profile.

16. The system of claim 11, wherein the location of the redeemed item and the time of the redeemed item are included in the redemption notification.

17. The system of claim 11, wherein
the transmitting device of the processing server is further configured to electronically transmit a data request to a third party, wherein the data request includes at least an item identifier further included in the redemption notification, and
the receiving device of the processing server is further configured to receive redemption data from the third party, wherein the redemption data includes at least the location of the redeemed item and the time of the redeemed item.

18. The system of claim 11, wherein
the redemption notification further includes a primary account number, and
the transaction message includes an additional data element configured to store the primary account number.

19. The system of claim 11, further comprising:
an account database of the processing server configured to store an account profile related to a transaction account, wherein the account profile includes at least a primary account number and one or more item identifiers, wherein
the redemption notification further includes an item identifier included in the one or more item identifiers, and
the transaction message includes an additional data element configured to store the primary account number.

20. The system of claim 11, wherein the redemption notification originates from an electronic wallet configured to convey payment credentials stored in the one or more additional data elements included in the received transaction message.
